(19) United States
(12) Patent Application Publication
(10) Pub. No.: US 2008/0292944 A1
(43) Pub. Date: Nov. 27, 2008

(54) Silver Gas Diffusion Electrode for Use in Air Containing Co2, and Method for the Production Thereof

(75) Inventors: Roland Beckmann, Luenen (DE); Karl-Heinz Dulle, Olfen (DE); Peter Woltering, Neuenkirchen (DE); Randolf Kiefer, Gelsenkirchen (DE); Frank Funck, Muelheim (DE); Wolfram Stolp, Hamm (DE); Hans-Joachim Kohnke, Kassel (DE); Joachim Helmke, Calden (DE)

Correspondence Address: MARSHALL & MELHORN, LLC, FOUR SEAGATE - EIGHTH FLOOR, TOLEDO, OH, 43604, US

(73) Assignees: UHDE GMBH, Dortmund (DE); GASKATEL GESELLSCHAFT FÜR GASSYSTEME DURCH KATALYS, Kassel (DE)

(21) Appl. No.: 11/632,789

(22) PCT Filed: Jul. 9, 2005
(86) PCT No.: PCT/EP05/07467

§ 371 Date: Jul. 30, 2008

(30) Foreign Application Priority Data
Jul. 19, 2004 (DE) 10 2004 034 885.5

(51) Int. Cl. H01M 4/88; H01M 4/90

(52) U.S. Cl. 429/42; 264/175

(57) ABSTRACT

The invention relates to a method for the production of a gas diffusion electrode from a silver catalyst on a PTFE-substrate. The pore system of the silver catalyst is filled with a moistening filling agent. A dimensionally stable solid body having a particle size greater than the particle size of the silver catalyst is mixed with the silver catalyst. Said compression-stable mass is formed in a first calendar in order to form a homogenous catalyst band. In a second calendar, an electroconductive discharge material is embossed in the catalyst band, and heating takes places between the first and the second calendar by means of a heating device, wherein at least parts of the moistened filling agent are eliminated. The invention also relates to a gas diffusion electrode which is produced according to said method.

The object of this invention is an oxygen-consumption electrode in alkaline electrolytes for operation with gas mixtures that contain CO₂, such as air, for example, and their production.

Alkaline electrolytes have been used as ion conductors in electrochemical process technologies for more than 150 years. They mediate the current transport in alkaline batteries and in alkaline electrolyzers and also in alkaline fuel cells. Some of these systems are hermetically sealed and therefore do not come into contact with atmospheric oxygen while others, in particular in chlorine-alkali electrolysis and alkaline fuel cells, must even be supplied with atmospheric oxygen. It has thereby been demonstrated experimentally that operation with unpurified air that contains CO₂ reduces the operating life of the system.

One reaction of the prior art of the typical alkaline electrolytes potassium hydroxide solution and sodium hydroxide solution with the carbon dioxide in the air leads to the formation of carbonates and water:

CO₂+2KOH->K₂CO₃+H₂O (1)

Depending on the pH of the remaining solution, the carbonate either crystallizes out or remains in solution. This situation is undesirable for several reasons:
In chlorine-alkali electrolysis, the objective is to produce sodium hydroxide solution and not sodium carbonate. The carbonization therefore reduces the efficiency of the system.
In alkaline fuel cells, the conductivity of the potassium hydroxide solution is reduced by the formation of potassium carbonate. This phenomenon becomes noticeable in particular at high current densities and has a negative effect on the electrical efficiency.
In zinc/air cells or also in alkaline fuel cells, the carbonate can crystallize in the pores of the porous gas diffusion electrode and thus completely block the entry of air. In that case, the batteries or fuel cells can thereby become unusable.

For these reasons, systems with alkaline electrolytes are preferably operated not with air but with pure oxygen, or CO₂ filters are integrated into the systems. Depending on the volume of the air flow, various filtering methods are used. Pressure Swing Absorption systems can be operated economically for large volumes of air, although for smaller quantities, a solid filter or a liquid filter must be used.

The problem of carbonizing has long been known in the applicable prior art. Alkaline fuel cells (AFC) were extensively researched in the period from 1950 to 1975. During the energy crises of those years, the AFC was considered an effective and environmentally friendly energy converter. Therefore, in spite of the well-known carbonizing problems, tests were conducted to determine the effect of atmospheric carbon dioxide on the efficiency of the cells. The results obtained at the time confirmed the theory that the operation of alkaline fuel cells with unpurified air is impossible over the long run, because the cells fail after a few hundred hours. The core of the problem is that the pores of the gas diffusion electrodes become clogged by carbonates. A summary of these results was published in “Kordesch, Hydrocarbon Fuel Cell Technology, Academic Press, 1965, pp. 17-23”. The findings of these earlier tests can be summarized by saying that hydrophilic electrodes carbonize faster than hydrophobic electrodes, and carbonization proceeds more rapidly at high potentials than at low potentials.

A more recent study was published recently in “Gülzow, Journal of Power Sources 127, 1-2, p. 243, 2004”. This publication measured the enrichments of carbonates in potassium hydroxide solution during long-term operation. In contrast to Kordesch's observations, no saturation of the carbonization occurred in this case.

Gas diffusion electrodes (hereinafter called “GDE”) have been used for many years in batteries, electrolyzers and fuel cells. The electrochemical reaction takes place inside these electrodes only at the three-phase boundary. The three-phase boundary is the term given to the area in which the gas, electrolyte and mechanical conductor meet one another. For the GDE to work effectively, the metal conductor must simultaneously be a catalyst for the desired reaction. Typical catalysts in alkaline systems are silver, nickel, manganese dioxide, carbon and platinum, among many others. For the catalysts to be particularly effective, they must have a large surface area. This large surface area is achieved by finely divided powder or porous powder with an internal surface area.

The liquid electrolyte is pulled into such fine porous structures by capillary action. This absorption is more or less complete depending on the viscosity, surface tension and pore radii. However, the capillary action is particularly strong precisely with alkaline electrolytes, because potassium hydroxide solution and sodium hydroxide solution have a slightly wetting action, and their viscosity is low at the conventional temperatures of use around 80° C.

So that the GDE is not completely filled with electrolyte—i.e. so that gas can also enter easily—three methods can be adopted:
Pores with a diameter of more than 10 μm are produced, which cannot be filled with electrolyte at a slightly elevated gas pressure (50 mbar).
Hydrophobic materials in part are used in the electrode structure and thereby prevent the wetting.
The catalyst surfaces react to electrolytes with different degrees of hydrophobia. In particular with catalysts that contain carbon, the hydrophobicity can be modified by the controlled removal of certain surface groups.

Typically, all methods are used in the production of GDE. The pore size can be defined by the selection of the primary material and by additional pore-forming agents. The manufacturing parameters pressure and temperature also have an effect on the pore size. The hydrophobicity is defined by the plastic powder—generally PTFE or PE—and its proportion by weight and distribution. The hydrophobicity of the catalyst is the result of factors that depend on the material and the manner in which it is manufactured/treated.

The prior art describes two basic methods for the production of gas diffusion electrodes made of mixtures of PTFE and catalyst. These methods are described in the patents DE 29 41 774 and U.S. Pat. No. 3,297,484. The catalyst and metallic conductor used are generally carbons with the catalyst deposited on it—although in rare cases they can also be pure metal catalysts, such as, for example, those described in WO 03/004726 A2. If the system consists of only one component (pure metal or alloy), and not of a heterogeneous mixture of carbon and metal (supported catalyst), the wetting properties on the microscopic level are easier to adjust than in supported catalysts.

A wide variety of methods are described in the prior art for the removal of carbon dioxide from the air. For example, the air can be guided through a zeolite bed, as described in D 699 02 409, which absorbs the carbon dioxide until the bed is saturated. At higher flow rates, the Pressure Swing Absorption process is used, as described in DE 696 15 289, for example. In the potash process, which is not described here in any further detail but is a standard process used in laboratories, potassium hydroxide solution is transformed into potassium carbonate by the absorption of CO₂.

Why the absorption of CO₂ into the electrolyte is not possible under certain operating conditions has never been adequately explained. However, there are a number of observations that confirm that electrodes that are easily wetted tend toward carbonization, while strongly hydrophobic electrodes do not exhibit this behavior. Therefore a sufficiently high hydrophobicity could be achieved by the addition of large amounts of PTFE powder, as is often indicated in the literature. However, that would also reduce the gas exchange and reduce the efficiency of the electrode. Therefore, to produce an electrode that is suitable for operation in air that contains CO₂, all the parameters that govern the hydrophobicity must be satisfied:

Hydrophobic Catalyst Surface.
The hydrophobicity of the smallest pores of the gas diffusion electrode is defined by the wetting characteristic of the catalyst. In this case, silver is characterized by a maximum 2-molecular wetting. For a silver amalgam surface, the wetting is only monomolecular.

Hydrophobic Binder Material:
PTFE as the binder material of the electrode can have a hydrophobizing effect on account of the poor wettability of the pores in the range of from a few tenths of a millimeters to 5 μm. A uniform hydrophobization can be achieved by the creation of a suspension or “reactive mixing”.

Hydrophobic Pore Size:
The pore radii that can no longer be flooded with electrolyte under the conditions indicated above are determined from the operating conditions and the Hagen-Poiseuille Law. Depending on the gas pressure conditions, these radii are between 5 and 20 μm.

pH
The pH of the catalyst represents an additional variable. The measurement of the pH is conventional for catalysts that contain carbon. However, any potassium carbonate that may be present is immediately decomposed by an acid surface into potassium hydroxide solution and carbon dioxide.

In particular the pore size is difficult to define on rolled electrodes, because at the rolling pressures required, a collapsing of large pores in the pore system is possible. The object of the invention is therefore to make available an improved method in which the pore size and the other parameters can be controlled so that carbonization no longer occurs during the electrolysis operation. The invention teaches that this object is accomplished as described in claim 1.

To prevent the above mentioned collapse, the following method is applied: Analogous to the method described in WO 03/004726 A2, a two-stage process is used for the production of the electrode strip, whereby first, in a first calendering step, the catalyst/PTFE mixture is rolled out into a thin strip and then introduced into a metallic support in a second calendering step. As described in that publication, in this step a filler is added to the catalyst powder which absorbs the rolling force in the first calendering step.

In contrast to the method described in WO 03/004726 A2, this filler material is removed prior to the second calendering by a heating device, such as a hot-air fan, for example. In this manner, the electrode arrives at the second calendering step with a defined pore radius. Because this second calendering step presses the electrode into a metallic support with only a small application of force, and the change in the thickness of the electrode can be measured, the reduction in size of the pore system can thereby also be measured. Therefore the hydrophobic pore size can be defined by an appropriate adjustment of the roll gap.

As long-term tests have shown, carbonization no longer occurs with the GDE electrode manufactured as described above, even in the presence of atmospheric CO₂, and uninterrupted long-term operation becomes possible.

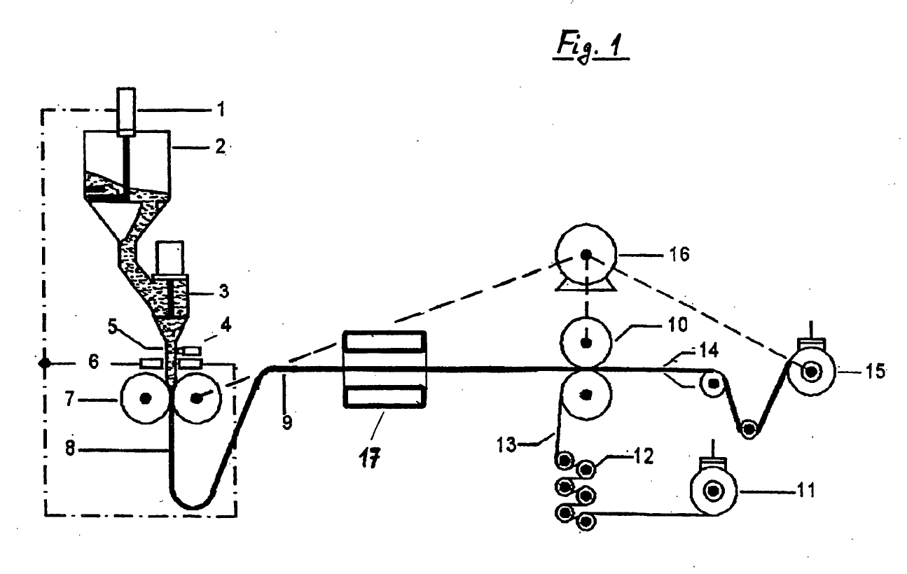

The manufacturing method for the GDE is illustrated in greater detail in FIG. 1, whereby the reference numbers 1 to 16 listed below and the corresponding description correspond to those in WO 03/004726 A2. The electrode strip that comes out of the strip roller 7, the first calendering step, is conducted into the heating device 17, where the electrode strip is heated so that the filler is removed from the electrode strip. The heating can be transmitted both by radiation as well as by the blowing of hot air, or a combination of the two methods.

### NOMENCLATURE

1 Turntable
2 Reservoir
3 Impact pulverizer
4 Powder funnel
5 Beater
6 Photoelectric barrier
7 Strip roller
8 Electrode strip
9 Guide rail
10 Mesh roller
11 Mesh roll
12 Deflector pulley
13 Discharge mesh
14 Edge stripper
15 Spool for electrode band
16 Drive motor
17 Heating device

1. A method for the production of a gas diffusion electrode from a silver catalyst on a PTFE substrate, whereby the pore system of the silver catalyst is filled with a wetting filler material, a dimensionally stable solid object with a grain size that is greater than that of the silver catalyst is mixed with the silver catalyst, this compressible mass is shaped in a first calendering step into a homogeneous catalyst strip, and is impressed in a second calendering step into an electrically conducting discharge material, characterized in that between the first and second calendering steps, heating is performed by means of a heating device, in which at least parts of the wetting filler material are eliminated.

2. A gas diffusion electrode produced according to the method of claim 1.

3. A gas diffusion electrode according to claim 2:
containing a pore structure and hydrophobicity that are appropriate for the reduction of oxygen from gas mixtures containing CO₂ in alkaline electrolytes, in particular however potassium hydroxide solution or sodium hydroxide solution, whereby
the CO₂ desorption from the electrolyte dominates with respect to the CO₂ absorption,
there is a pressure gradient between the inner pores filled with electrolyte and the external electrolyte that promotes the desorption,
the pressure gradient is realized by a particularly strong capillary partial vacuum,
the capillary partial vacuum is produced by a particularly hydrophobic catalyst surface,
solver is used as the catalyst and the silver catalyst is amalgamated, and
the catalyst is hydrophobized by an additional PTFE addition.
